(19) United States
(12) Patent Application Publication
(10) Pub. No.: US 2006/0231691 A1
(43) Pub. Date: Oct. 19, 2006

(54) Apparatus and method for covering and irreversibly tying an object

(76) Inventor: James Brett Edgren, Mission (CA)

Correspondence Address: Laurence C. Bonar, 917 Logan Street, Port Townsend, WA, 98368-2337, US

(21) Appl. No.: 11/105,812

(22) Filed: Apr. 13, 2005

(51) Int. Cl. F16L 3/12

(52) U.S. Cl. 248/74.3

(57) ABSTRACT

A cover for covering (completely or a portion thereof) and irreversibly tying an object is disclosed. The cover includes a base; a fastening head attached to the base; and a fastening tail having an attached end and a free end, the fastening tail being attached at the attached end to the base, the free end being, when the base is positioned in relation to the object, insertably engageable with the fastening head so as to prevent disengagement of the fastening tail and the fastening head, thereby maintaining the base positioned in relation to the object. In variations, the fasteners may be continuous. Various embodiments are suitable for sealing and repairing holes or cracks in pipes, tubes and engine exhaust components, bundling a stack of objects such as tiles, carrying or hanging bundled objects, forming a backrest for a chair or upholstery cover, forming a lid for a container, and being packaged in a roll.

### 1. TECHNICAL FIELD

The present invention relates to protecting, including repairing and packaging, an object and, in particular, to an apparatus and method for covering and irreversibly tying an object.

### 2. BACKGROUND OF THE INVENTION

Various conventional schemes have been proposed for covering, including sealing, portions of objects such as engine exhaust components in need of repair and for irreversibly or non-releasably tying objects, such as when a cover for sealing a portion of an engine exhaust component is tied to the engine exhaust component or when various goods such as tiles are bundled together as packages for storing, shipping or other purposes.

However, such conventional schemes are often complicated by requiring the use of a tool. Some conventional schemes involve applying a cover to an object and then securing a fastener, initially separated from the cover, while holding the cover in place. Such simultaneous holding and securing is inconvenient for the user and may even require the cooperation of multiple users, particularly so when the use of a tool is also required. Some conventional schemes involve the use of singly packaged devices of fixed size, which are limited to covering or irreversibly tying objects in a limited range of sizes.

The present invention satisfies the need for an aesthetically appealing and economical device that is easy to manufacture and use.

### 3. SUMMARY OF THE INVENTION

Shortcomings described above can be addressed by providing an apparatus and method of covering and irreversibly tying an object. The apparatus includes a base; a fastening head attached to the base; and a fastening tail having an attached end and a free end, the fastening tail being attached at the attached end to the base, the free end being, when the base is positioned in relation to the object, insertably engageable with the fastening head so as to prevent disengagement of the fastening tail and the fastening head, thereby maintaining the base positioned in relation to the object.

It is an object of the present invention to include at least one embodiment suitable for sealing and repairing holes, cracks or other sources of leaks in a straight section of a pipe, tube or similarly shaped object, including an engine exhaust component.

It is an object of the present invention to include at least one embodiment suitable for sealing and repairing holes, cracks or other sources of leaks in an angled section of a pipe, tube or similarly shaped object, including an engine exhaust component.

It is an object of the present invention to include at least one embodiment suitable for bundling a stack of objects such as tiles or similarly shaped objects.

It is an object of the present invention to include at least one embodiment suitable for bundling loose materials such as wood pieces, including firewood, and wires, including electrical wires.

It is an object of the present invention to include at least one embodiment suitable for carrying or hanging bundled objects.

It is an object of the present invention to include at least one embodiment suitable for forming a backrest for a chair.

It is an object of the present invention to include at least one embodiment suitable for forming an upholstery cover.

It is an object of the present invention to include at least one embodiment suitable for forming a lid for a container.

It is an object of the present invention to include at least one embodiment suitable for being packaged in a roll.

### 4. BRIEF DESCRIPTION OF THE DRAWINGS

The apparatus and method of the present invention will now be described with reference to the accompanying drawing figures, in which:

FIG. 1 is a perspective view of a cover suitable for irreversibly tying an object in accordance with a first embodiment of the invention, showing three fasteners;

FIG. 2 is a plan view of a cover suitable for covering and irreversibly tying an elbow-shaped object in accordance with a second embodiment of the invention;

FIG. 3 is a perspective view of the cover shown in FIG. 2 and an elbow insert, showing the cover and elbow insert partially covering an elbow-shaped object;

FIG. 4 is a top view of a cover having an elongated fastening head in accordance with a third embodiment of the invention;

FIG. 5 is a top view of a cover having fastening heads attached directly to the base in accordance with a fourth embodiment of the invention;

FIG. 6 is a top view of a cover having a base formed of two parallel, spaced apart strips in accordance with a fifth embodiment of the invention;

FIG. 7 is a top view of a cover having a plurality of longitudinally connected bases in accordance with a sixth embodiment of the invention;

FIG. 8 is a top view of a cover having bases coincident with corresponding fasteners in accordance with a seventh embodiment of the invention;

FIG. 9 is a top view of a cover having two pairs of two parallel, spaced apart fasteners in accordance with an eight embodiment of the invention;

FIG. 10 is a perspective view of the cover shown in FIG. 9, showing the cover covering a stack of tiles;

FIG. 11 is a top view of a cover having a handle in accordance with a ninth embodiment of the invention; and

FIG. 12 is a top view of a cover covering a gap between backrest supports of a chair in accordance with a tenth embodiment of the invention.

In the figures and description herein, similar and identical features of the various embodiments are referenced by the same reference character.

### 5. DETAILED DESCRIPTION OF THE INVENTION

An apparatus for covering and irreversibly tying an object includes means for supporting; means for fastening, said fastening means having an attached end and a free end, the fastening means being attached at said attached end to said means for supporting; and means for receiving said fastening means, said receiving means being attached to said means for supporting, whereby said fastening means is, when said means for supporting is positioned in relation to the object, insertably engageable with said receiving means so as to prevent disengagement of said fastening means and said receiving means, thereby maintaining said means for supporting positioned in relation to the object.

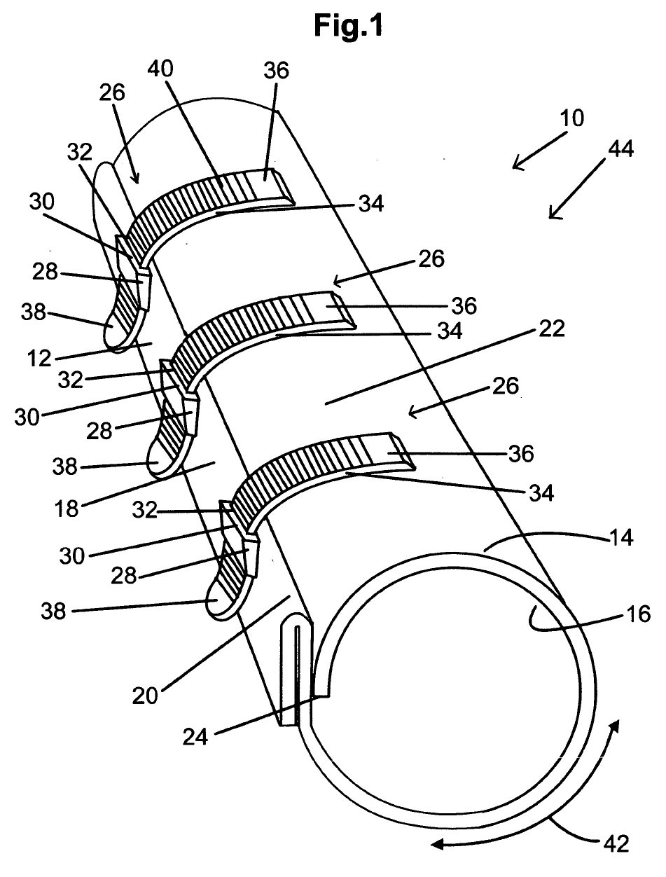

Referring to FIG. 1, the apparatus may be implemented in accordance with a first and preferred embodiment of the invention as a cover suitable for covering and irreversibly, or non-releasably, tying the object. The cover in accordance with the first embodiment is shown generally at 10 in FIG. 1. The cover 10 includes a support or base 12, and optimally, three fasteners 26.

The base 12 is preferably made or formed of a sheet of fabric, mesh, paper, plastic, metal of any thickness that permits bending including stainless steel sheet metal, or any other deformable or bendable material. The base 12 has an outer surface 14, and an inner surface 16 opposite the outer surface 14. On one side of the outer surface 14 of the base 12 is a side 18 that terminates at an edge 20, and on the opposing side of the outer surface 14 is an opposing side 22 that terminates at an opposing edge 24. The base 12 has, optimally, a generally rectangular shape so as to form a cylindrical shape when forming the enclosure 44 described below.

Each fastener 26 includes a fastening head 28 and a fastening tail 34. The fastening head 28 is directly attached to the base 12 at the side 18 and set back from the edge 20. A receiving member 30 located within the fastening head 28 has an opening 32 that passes entirely through the receiving member 30. Although not visible in FIG. 1, a pawl within the receiving member 30 projects into the opening 32 in the manner of a standard tie-wrap as generally known in the art.

A fastening tail 34 is attached at an attached end 36 to the base 12 at the opposing side 22 and set back from the opposing edge 24. A tail end 38 of the fastening tail 34 projects freely from the attached end 36. A series of parallel, narrowly spaced projections form ribs 40 along the outer surface of the fastening tail 34 at the tail end 38. Alternatively, the fastener 26 may be continuous with the fastening head 28 and the fastening tail 34 attached and encircling the entire base 12.

The fastening heads 28 and the fastening tails 34 are preferably attached to the base 12 by welding, but may be attached by any other suitable method, including riveting, attaching by nut and bolt, attaching by screw and threaded aperture or integrally attaching. In FIG. 1, the base 12 near the edge 20 is shown reinforced or stiffened relative to the remainder of the base 12 by folding the base 12 at the edge 20 so as to increase the thickness of the base 12 near the edge 20. Additionally or alternatively, the base 12 at the side 18, including at or near the edge 20, the base at the opposing side 22, including at or near the opposing edge 24, or the base at both the side 18 and the opposing side 22 are preferably augmented by reinforcing, stiffening or strengthening. Such augmentation may be achieved not only by folding a given edge, but also by altering the material, or thickness of material, of the base 12 with proximity to the given edge, using different materials at different proximities to the given edge, applying different coatings or material treatments to different portions of the base 12, or by other augmentation techniques.

The fastening head 28 and the fastening tail 34 are of such dimensions and flexibility as to permit the fastening head 28, the fastening tail 34, or both the fastening head 28 and the fastening tail 34 to bend toward each other in a fastening direction 42 indicated by the fastening direction 42 arrow shown in FIG. 1. The cover 10 is operable to form a complete loop, such as the enclosure 44 shown in FIG. 1, when the fastening tail 34 at the tail end 38 is inserted into the opening 32. Setting back the fastening heads 28 and/or the fastening tails 34 from the edges 20 and 24, respectively, permits the side 18 and the opposing side 22 of the base 12 to overlap when the enclosure 44 is formed. The enclosure 44 may be formed by overlapping the side 18 and the opposing side 22 of the base 12, as shown in FIG. 1, by abutting the edges 20 and 24 against each other (not shown), or by inserting additional material of an appropriate material type, such as the material of the base 12, between the edges 20 and 24 (not shown).

A pawl 62 (described below and shown in FIG. 6) within the receiving member 30 engages one or more of the ribs 40 as the fastening tail 34 is inserted into the fastening head 28, thereby preventing the fastening tail 34 and the fastening head 28 from being disengaged. The engagement of the fastening head 28 and the fastening tail 34 occurs when the fastening tail 34 is inserted into the fastening head 28 and can advantageously be accomplished without the use of a tool.

Each fastening head 28 is attached to the base 12 along the side 18 opposite to a corresponding fastening tail 34 attached to the base 12 along the opposing side 22. Each opposing pair of fastening head 28 and corresponding fastening tail 34 forming a single fastener 26 are in substantial alignment along a direction transverse, or perpendicular, to the fastening direction 42. The opposing pairs of fastening heads 28 and corresponding fastening tails 34 need not be in precise transverse alignment, provided the cover 10 is dimensioned and formed of sufficiently flexible material to permit the tail end 38 of the corresponding fastening tail 34 to be inserted into the opening 32 of the fastening head 28.

The cover 10 in accordance with the first embodiment is particularly suitable for covering at least a circumference of a round, lengthy object such as a pipe, tube or similarly shaped object, including an exhaust component of an internal combustion engine such as an engine exhaust muffler or catalytic converter. For example, the cover 10 may be used for repairing an object, such as a tube, pipe or engine exhaust component, having one or more holes, cracks or other sources of leaking by circumferentially covering the object at the location of the source of the leak and irreversibly tying the object so as to form a patch or seal about the source of the leak. For uses that are subject to high temperatures, such as a use involving an engine exhaust component or other pipe or tube, the base 12 and the fasteners 26 are preferably made of a heat resistant material or materials. For example, the base 12 and the fastening tails 34 may be made of bendable or deformable sheet metal, and the fastening heads 28 may be made of other forms of heat resistant metal. Chrome plating may be applied to the cover 10 for enhanced aesthetic appeal. Augmenting the base 12 as described above may provide better sealing around a hole or crack in the object. Additionally or alternatively, a sealant, adhesive or lining may be applied for better sealing. For an object having a circumference greater than the longitudinal distance between the edge 20 and the opposing edge 24 of the cover 10, an extension piece (not shown) of appropriate dimensions and material type, including a generally rectangular extension piece made of heat resistant sheet metal, may be applied to the object so as to fill any gap between the edge 20 and the opposing edge 24 when the enclosure 44 is covering and irreversibly tying the large circumference object, so as to form a seal. In a variation (not shown), the base 12 may be in the shape of a trapezoid such that the cover 10 is suitable for circumferentially covering a cone-shaped or otherwise flared object.

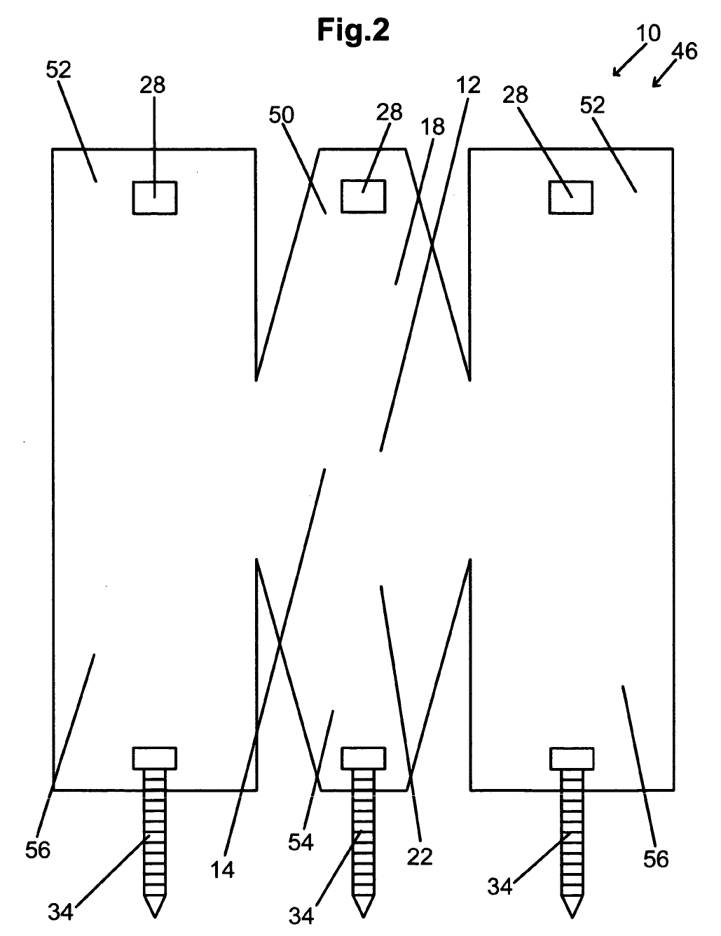

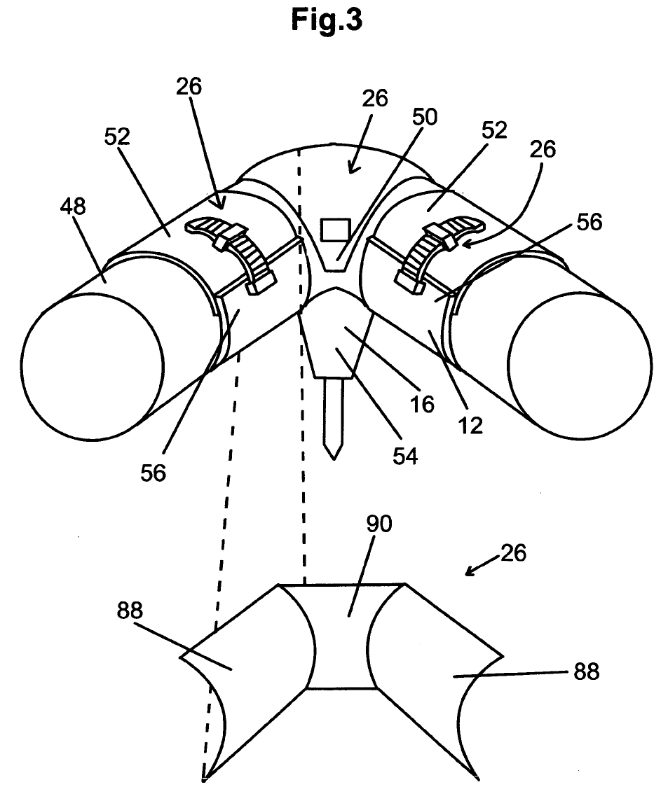

Referring to FIGS. 2 and 3, the cover 10 in accordance with a second embodiment of the invention is in the form of a pipe elbow cover 46. The pipe elbow cover 46 has a shape particularly suitable for circumferentially covering and irreversibly tying an object having the shape of an angled corner of a pipe, tube or exhaust component, such as the elbow 48 shown in FIG. 3. At the side 18 of the outer surface 14 of the base 12 of the pipe elbow cover 46 is a central flap 50 adjacently flanked by a pair of angled flaps 52. At the opposing side 22 is an opposing central flap 54 adjacently flanked by an opposing pair of angled flaps 56. One fastening head 28 is attached to the central flap 50 opposite to a corresponding fastening tail 34 attached to the opposing central flap 54. Similarly, one fastening head 28 is attached to each angled flap of the pair of angled flaps 52 opposite a corresponding angled flap of the opposing pair of angled flaps 56. In FIG. 2, the angled flaps 52 and 56 are shown flat prior to bending or pressing the pipe elbow cover 46 to place the angled flaps 52 and 56 at respective angles relative to the central flaps 50 and 54.

FIG. 3 shows pipe elbow cover 46, at the inner surface 16 of the base 12, partly covering the elbow 48, but with some of the fasteners 26 unengaged. Engaging all the fasteners 26 would cause the cover 10 to irreversibly tie the elbow 48 so as to form a seal around the elbow 48. In this manner, the pipe elbow cover 46 is operable to repair a leak in any elbow-shaped pipe or other round object having an angled corner. The pipe elbow cover 46 is particularly suitable for use with the elbow insert 86 shown in FIG. 3. Prior to engaging the fasteners 26, the elbow insert 86 is placed against the elbow 48 as indicated by the dotted lines in FIG. 3 and then the fasteners 26 are engaged such that the central and angled flaps 50, 52, 54 and 56 cover the elbow insert 86. The elbow insert 86 is preferably shaped to substantially conform to the shape of the elbow 48 along elbow insert sides 88 and to provide a smoothly curved central section 90 against which the central flap 50 and the opposing central flap 54 may be placed. When the elbow insert 86 is placed against the elbow 48, the shape of the portion of the elbow 48 adjacent the central section 90 may be such that a gap between the elbow 48 and the central section 90 is created. In such a case, the elbow insert 86 permits the central flap 50 and the opposing central flap 54 to curve smoothly when the fasteners 26 are engaged and tightened.

One or more covers 10 in accordance with the first embodiment and one or more covers 10 in accordance with the second embodiment may be used advantageously in combination to cover and irreversibly tie straight and angled sections of a pipe, tube or similarly shaped object. Covers 10 having similar or different shapes may overlap with each other or with one or more extension pieces for better sealing.

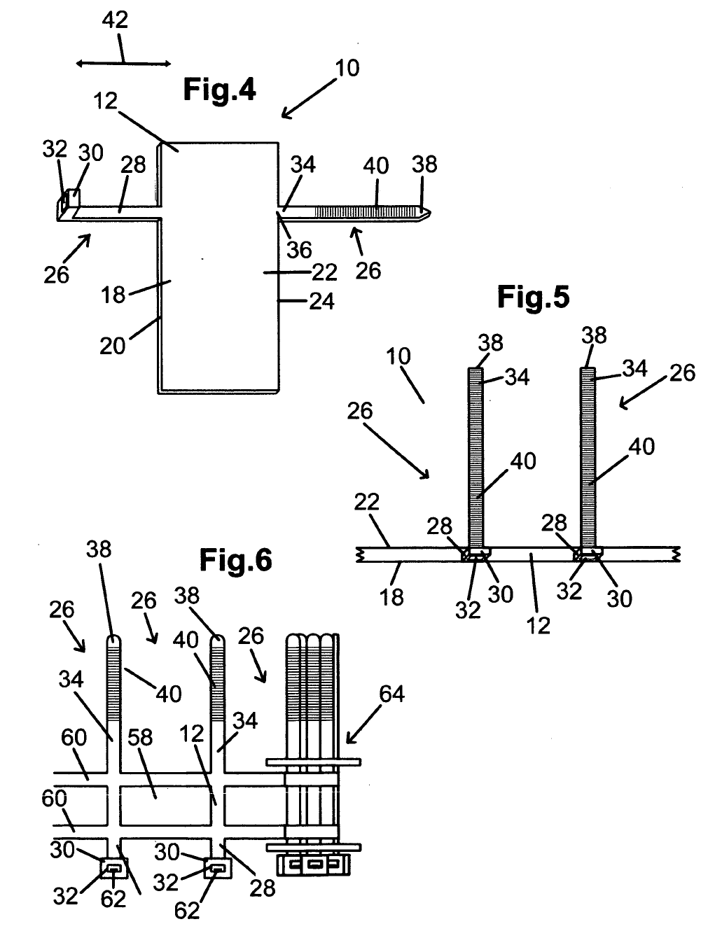

In FIG. 4, the cover 10 in accordance with a third embodiment of the invention has a single fastener 26 which includes an elongated fastening head 28. The elongated fastening head 28 is attached to the base 12 at the side 18 and projects away from the edge 20. The receiving member 30 of the elongated fastening head 28 is located at a distal end of the fastening head 28 distant from the edge 20. The fastening tail 34 is shown in FIG. 4 attached to the base 12 at the opposing side 22 and projecting away from the opposing edge 24. Preferably, the base 12, fastening head 28 and the fastening tail 34 are made of the same material, such as plastic, fabric or sheet metal, and the fastening head 28 and the fastening tail 34 are integrally attached to the base 12. However, a combination of different materials may be used, and the fastening head 28 and the fastening tail 34 may be attached to the base 12 by any suitable means.

The fastening head 28 and the fastening tail 34 are in substantial transverse alignment to permit the fastening head 28 and the fastening tail 34 to engage when the cover 10 forms a complete loop in the fastening direction 42 around one or more objects, including forming a complete loop around a portion of the one or more objects. More than one object may be covered and irreversibly tied, and even patched or sealed, provided the width of the base 12 and the lengths of fastening head 28 and the fastening tail 34 permit the cover 10 to form a complete loop around and surround the objects when the fastening head 28 and the fastening tail 34 are engaged.

FIG. 4 shows the base 12 having a rectangular shape, but the base 12 may have any particular shape, and may include holes. It is not necessary, for example, for the sides 18 and 22 to be the longest sides of the base 12. Variations of the cover 10 are suitable for covering or irreversibly tying objects of a variety of different shapes and sizes.

In FIG. 5, a portion of the cover 10 in accordance with a fourth embodiment of the invention is shown. The cover 10 includes a plurality of fasteners 26 attached to the base 12. The base 12 in accordance with the fourth embodiment has an elongated shape of continuous length, thus only a portion of the base 12 is shown in FIG. 5. The fastening heads 28 and the fastening tails 34 of the fasteners 26 are parallel and spaced apart along the side 18 and the opposing side 22, respectively. Although not necessary, the distances between fasteners 26 are preferably uniform. The fastening heads 28 include the receiving members 30, which are attached directly onto the outer surface 14 of the base 12 and are in substantial transverse alignment with the fastening tails 34. Alternatively, the base 12 may be attached to any point on the fasteners 26. Differences between the third and fourth embodiments include the respective shapes and placement of the receiving members 30, the respective shapes of the tail ends 38, and the respective locations of the rib 40 closest to the base 12.

Referring to FIG. 6, the cover 10 in accordance with a fifth embodiment of the invention includes a plurality of holes or cut-outs 58 in the base 12. The base 12 thus forms a plurality of, for instance, two, parallel, spaced apart strips 60 suitable for covering one or more objects. It is not necessary for both strips 60 to be made of the same material. For example, one strip 60 may be made of a hard or firm material for supporting an object to be covered and irreversibly tied, and the other strip 60 may be made of a soft material. Different selections of materials can advantageously result in an improved aesthetic appearance. As with the fourth embodiment, the fifth embodiment includes a plurality of fasteners 26 in parallel, spaced apart relation along a continuous length of the base 12. A pawl 62, located within the opening 32 of the receiving element 30 of each fastening head 28, permits the corresponding fastening tail 34 to be insertably engaged with the fastening head 28 so as to prevent each fastening head 28 and the corresponding fastening tail 34 to be disengaged. Differences between the fourth and fifth embodiments include the respective orientations of the openings 32, the respective shapes of the tail end 38 and the respective locations of the ribs 40 closest to and furthest from the base 12.

The cover 10 is suitable in various variations for being packaged in the form of a roll. For example, FIG. 6 shows a roll 64 of the cover 10 in accordance with the fifth embodiment of the invention. A user may conveniently unroll a portion of the cover 10 and separate that portion from the portion remaining on the roll 64 by cutting the cover 10 at the base 12, for example.

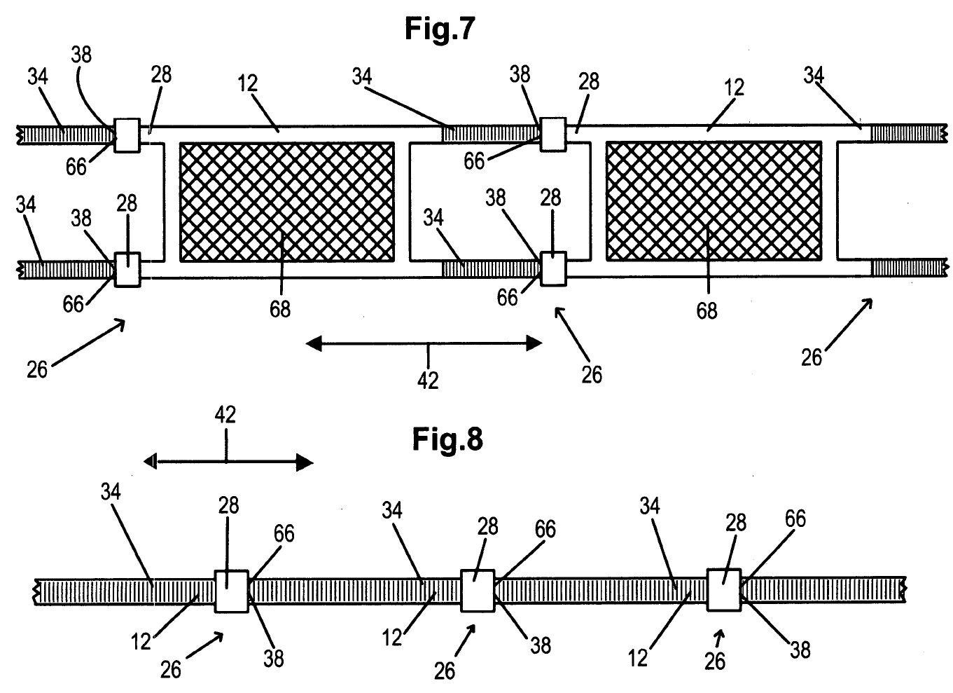

Referring to FIG. 7, the cover 10 in accordance with a sixth embodiment of the invention includes a plurality of bases 12 and respective pairs of parallel, spaced apart fasteners 26 attached to the bases 12. Adjacent bases 12 are longitudinally connected, as indicated by the fastening direction 42, at respective pairs of junctions 66 between their respective pairs of fasteners 26, thereby forming a chain of longitudinally connected bases 12. Preferably, each junction 66 is located at the tail end 38 of a fastening tail 34 attached to a given base 12 and a fastening head 28 attached to the base 12 adjacent the given base 12. The junctions 66 are made of a material and dimensioned to permit separation of adjacent bases 12 at the junctions 66. For example, adjacent bases 12 can be separated by cutting a pair of transversely adjacent fastening tails 34 at or near the junction 66. Each base 12 shown in FIG. 7 includes a mesh 68 that can be made of plastic, a fabric or woven material, or other material suitable for forming mesh-like structures.

Referring to FIG. 8, the cover 10 in accordance with a seventh embodiment of the invention includes a plurality of bases 12 and fasteners 26 attached to the oases 12, respectively. In the seventh embodiment, each base 12 preferably coincides with a corresponding fastener 26 as shown in FIG. 8, but may instead coincide with a portion of a corresponding fastener 26, including coinciding with all or a portion of a corresponding fastening head 28, a corresponding fastening tail 34, a corresponding tail end 38, or a combination thereof. Adjacent bases 12 are longitudinally connected, as indicated by the fastening direction 42, at respective junctions 66 between their respective fasteners 26. Preferably, each junction 66 is located at the intersection between the tail end 38 of a fastening tail 34 attached to a given base 12 and a fastening head 28 attached to the base 12 adjacent the given base 12. The dimensions and material type of the junctions 66 are preferably selected to facilitate separation of adjacent bases 12 at the junctions 66. For example, adjacent bases 12 can be separated by transversely cutting a fastening tail 34 at or near the junction 66. Such separation cuts may be made to form a fastener 26 having the same number of fastening heads 28 as it has fastening tails 34 or having one more fastening tail 34 than it has fastening heads 28, for example. A fastening tail 34 located at an end of the fastener 26 can be advantageously looped around to or past the opposite end and engaged (not shown here) with any one of the fastening heads 28 of the fastener 26. Alternatively, the fastening tail 34 at the end of the fastener 26 can be looped around itself and engaged (not shown here) with its immediately adjacent fastening head 28 or any fastening head 28 past its immediately adjacent fastening head 28, which may leave the opposite end of the fastener 26 unengaged and available for covering and tying the same or another object.

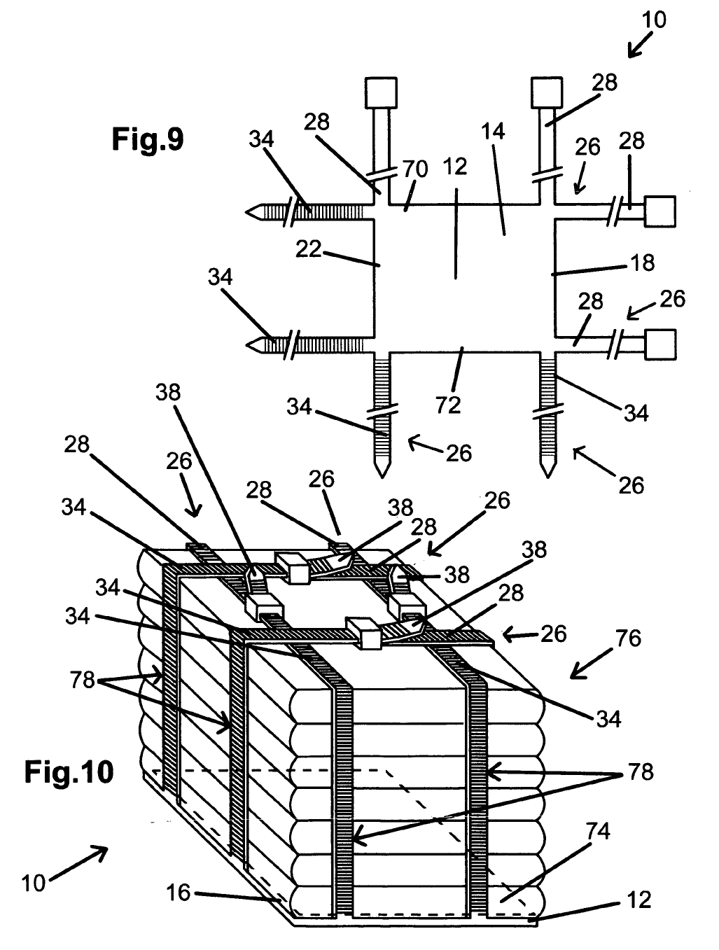

Referring to FIG. 9, the cover 10 in accordance with a eighth embodiment of the invention includes a base 12 having, on its outer surface 14, the side 18, the opposing side 22, a first end 70, and a second end 72 opposite the first end 70. The base 12 is preferably made or formed of a deformable or bendable material and may include a mesh (not shown in FIG. 9). A first pair of parallel, spaced apart fasteners 26 includes a pair of parallel, spaced apart fastening heads 28 attached to the base 12 at the side 18 and a pair of parallel, spaced apart fastening tails 34 attached to the base 12 at the opposing side 22. A second pair of parallel, spaced apart fasteners 26 includes a pair of parallel, spaced apart fastening heads 28 attached to the base 12 at the first end 70 and a pair of parallel, spaced apart fastening tails 34 attached to the base 12 at the second end 72.

The cover 10 in accordance with the eighth embodiment is particularly suitable for covering the bottom surface 74, as indicated by dotted outline in FIG. 10, of a stack of objects, such as the tiles 76 shown in FIG. 10, or similarly shaped objects, and irreversibly tying, including bundling, the stack of objects. By way of example showing the use of the cover 10, the inner surface 16 of the base 12 contacts the bottom surface 74 of the stack of tiles 76, and the fastening heads 28 and fastening tails 34 of each fastener 26 are engaged at the top of the stack of tiles 76 so as to completely form a loop 78 around the stack of tiles 76. Each loop 78 includes the fastening head 28, the fastening tail 34 and the portion of the base 12 between the fastening head 28 and the fastening tail 34. Four portions of the base 12 and the four fasteners 26 shown in FIG. 9 form four corresponding loops 78. By pulling the tail ends 38 of each fastener 26 after the fastening heads 28 and the fastening tails 34 have been engaged, the stack of tiles 76 can be as uniformly and as tightly tied as desirable.

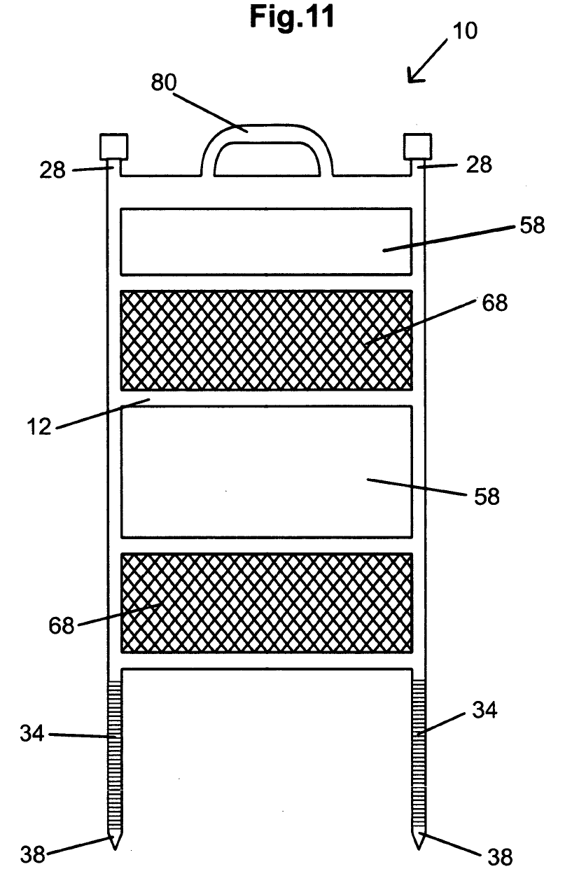

Referring to FIG. 11, the cover 10 in accordance with a ninth embodiment of the invention has a handle 80 attached to the base 12 of the cover 10. The handle 80 preferably includes a length of material disposed between two elongated fastening heads 28 or between the tail ends 38 of two fastening tails 34, and a loop formed on the length of material. Preferably, the handle 80 and the base 12 are made of the same material and integrally attached, although different materials may be used and the handle 80 may be attached to the base 12 by any suitable means. Although not necessary, FIG. 11 shows the base 12 having a plurality of sections comprised of mesh 68 and a plurality of cut-outs 58 forming a generally rectangular shape. The cover 10 in accordance with the ninth embodiment is particularly suitable for instances where it is desirable to carry or hang up one or more covered and irreversibly tied objects. For example, loose materials such as a stack of fire wood (not shown) may be bundled by the cover 10 and then conveniently carried by the handle 80. By way of another example, wires (not shown), such as electrical wires, running along a wall may conveniently be bundled and hung or otherwise fixed in place by the handle 80 at various points along the wall. The size of the cover 10 may vary depending on the intended application of a given embodiment of the invention. Objects having changeable shapes, such as a bundle of wires, may not come into continuous direct contact with any single portion of the cover 10 when covered and irreversibly tied by the cover 10.

The cover 10 in accordance with any embodiment described herein, including the third to seventh embodiments and the ninth embodiment, may advantageously cover and irreversibly tie one or more objects so as to give the objects an aesthetically appealing clean and finished appearance.

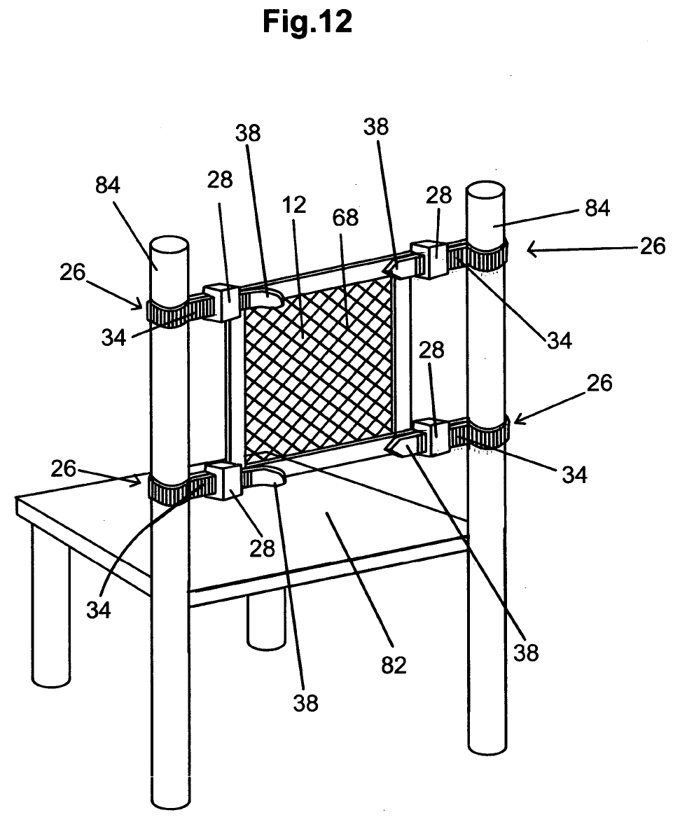

Referring to FIG. 12, the cover 10 in accordance with a tenth embodiment of the invention has fastening tails 34 projecting from corresponding fastening heads 28. The fastening heads 28 are shown attached to, including projecting from, the base 12 at or near each corner of the base 12. The cover 10 is fastened by wrapping the tail end 38 of each fastening tail 34 around one or more objects, or portions thereof, until the tail end 38 can be engaged with the corresponding fastening head 28, thereby forming a complete loop. Although the base 12 is shown in FIG. 12 as being generally rectangular and including the mesh 68, other shapes and materials such as cloth, fabric, vinyl, plastic, leather, suede, canvas, nylon and foam are possible.

Depending on the shape of the object or objects being covered and irreversibly tied, it is not necessary, nor even desirable in some cases, for the base 12 to come into direct contact with the object(s) in order to cover the object(s). For example, the cover 10 in accordance with the eighth embodiment shown in FIGS. 9 and 10 may suitably cover a stack of objects having a surface portion thereof that is concavely shaped. In such circumstances, the cover 10 may, when the object is covered and irreversibly tied by the cover 10, come into direct contact with cover 10 only at the fasteners 26, for example. As a further example, the cover 10 in accordance with the tenth embodiment may suitably cover and irreversibly tie a container (not shown), such as an open-top basket, so as to form a lid on the container for packing, moving or storage, for example. In such circumstances, the base 12 does not necessarily contact the basket itself, yet forms a lid covering the basket and its contents, if any. As shown in FIG. 12, the cover 10 in accordance with the tenth embodiment is also suitable for covering and irreversibly tying a chair 82 so as to cover the gap that would otherwise exist between a pair of backrest supports 84 of the chair 82. To do so, the tail end 38 of each fastening tail 34 is wrapped around one backrest support 84 until the tail end 38 can be engaged with the corresponding fastening head 28, thereby forming a complete loop around the backrest support 84. Pulling the tail ends 38 tightens the fasteners 26 to secure the cover 10 in place. The base 12 of the cover 10 in accordance with the tenth embodiment may be made of a fabric and/or mesh material and is suitable for use as a seat cover, backrest cover, cushion cover or other upholstery cover. For all variations, the fasteners 26 may be either discontinuous or continuous. For all variations, the base 12 may be solid or perforated, or a combination of the two, for instance, a mesh with solid borders. “Covering” in this application means covering all or any portion of the object to be irreversibly or non-releasably tied.

As will be apparent to those skilled in the art, in light of the foregoing disclosure, many alterations and modifications are possible in the practice of this invention without departing from the spirit or scope thereof For example, various features of each of the embodiments described herein may be suitably applied to other embodiments of the invention. Accordingly, the scope of the invention is to be construed in accordance with the substance defined by the following claims.

I claim:

1. An apparatus for irreversibly tying an object, the apparatus comprising:
a) a base;
b) a fastener attached to said base and having a fastening head and a fastening tail
said fastening tail, when said base is positioned in relation to the object, being insertably engageable with said fastening head so as to prevent disengagement of said fastening tail and said fastening head, thereby maintaining said base positioned in relation to the object.

2. The apparatus of claim 1, wherein said fastener is discontinuous, being comprised of a fastening head attached to said base at a first location, and a separate fastening tail attached to said base at a second location, such that when said fastening tail is inserted in said fastening head, said base is maintained in position in relation to the object.

3. The apparatus of claim 2, wherein said base has, on a surface thereof, a first side and a second side opposite said first side, said fastening head is attached to said base at said first side, said fastening tail is attached at said attached end to said base at said second side, and wherein at least a portion of the object is surrounded by at least a portion of said free end and at least a portion of said base when said base is positioned in relation to the object.

4. The apparatus of claim 1, wherein said fastening head has a passage therethrough dimensioned to permit said fastening tail to be inserted into said passage for engagement with said fastening head.

5. The apparatus of claim 4, wherein said fastening head comprises a pawl projecting within said passage, and said fastening tail comprises a plurality of narrowly spaced ribs for engaging with said pawl when said fastening tail is inserted into said passage.

6. The apparatus of claim 1, wherein said fastening head is attached to said base at an edge of said base.

7. The apparatus of claim 1, wherein said fastening head is attached to said base displaced from an edge of said base.

8. The apparatus of claim 1, wherein said fastening tail is attached at said attached end to said base at an edge of said base.

9. The apparatus of claim 1, wherein said fastening tail is attached at said attached end to said base displaced from an edge of said base.

10. The apparatus of claim 1, wherein at least a portion of said base is made from a group consisting of a fabric material, a plastic material, a heat resistant material, a leather material, a nylon material and a mesh.

11. The apparatus of claim 1, wherein said base is generally rectangular.

12. The apparatus of claim 1, wherein said base comprises a pair of flaps located on either side of a central flap.

13. The apparatus of claim 1, wherein at least one side of said base is augmented.

14. The apparatus of claim 1, further comprising a first plurality of said fastening heads and a second plurality of said fastening tails, each fastening head of said first plurality being in substantial transverse alignment with a corresponding one of said second plurality.

15. The apparatus of claim 14, wherein said fastening heads of said first plurality are in parallel, spaced apart relation, and said fastening tails of said second plurality are in parallel, spaced apart relation.

16. The apparatus of claim 14, wherein said first plurality includes a pair of fastening heads located on either side of a central fastening head and said second plurality includes a pair of fastening tails located on either side of central fastening tail.

17. The apparatus of claim 1, further comprising a plurality of said bases, said bases being longitudinally connected.

18. The apparatus of claim 17, wherein each of said bases comprise deformable material such that the apparatus is capable, prior to said fastening head and said fastening tail being engaged, of being rolled into a roll.

19. An apparatus for non-releasably tying an object, the apparatus comprising:
a) means for supporting;
b) means for fastening, said fastening means having an attached end and a free end, the fastening means being attached at said attached end to said means for supporting; and
c) means for receiving said fastening means, said receiving means being attached to said means for supporting,
whereby said fastening means is, when said means for supporting is positioned in relation to the object, insertably engageable with said receiving means so as to prevent disengagement of said fastening means and said receiving means, thereby maintaining said means for supporting positioned in relation to the object.

20. The apparatus of claim 19, wherein said fastening means is also attached to said receiving means, thereby providing a combined and continuous fastening and receiving means.

21. The apparatus of claim 19, wherein said means for supporting has, on a surface thereof, a first side and a second side opposite said first side, said receiving means is attached to said means for supporting at said first side, said fastening means is attached at said attached end to said means for supporting at said second side, and wherein at least a portion of the object is surrounded by at least a portion of said free end and at least a portion of said means for supporting when said means for supporting is positioned in relation to the object.

22. The apparatus of claim 19, wherein said receiving means comprises passage means for permitting passage through said receiving means, said passage means being dimensioned to permit said fastening means to be inserted into said passage means for engagement with said receiving means.

23. The apparatus of claim 22, wherein said receiving means comprises latch means for latching, said latching means projecting within said passage means, and said fastening means comprises an engagement means for engaging with said latch means when said fastening means is inserted into said passage means.

24. The apparatus of claim 19, further comprising a first plurality of said receiving means and a second plurality of said fastening means, each receiving means of said first plurality being in substantial transverse alignment with a corresponding one of said second plurality.

25. The apparatus of claim 19, further comprising a plurality of said means for supporting, said means for supporting of said plurality being longitudinally connected.

26. A method of irreversibly tying an object, the method comprising:
a) positioning a base in relation to the object; and
b) insertably engaging a fastening tail, said fastening tail being attached at an attached end of said fastening tail to said base, at a free end of said fastening tail with a fastening head attached to said base so as to prevent disengagement of said fastening tail and said fastening head, thereby maintaining said base positioned in relation to the object.

27. The method of claim 26, wherein positioning a base in relation to the object comprises surrounding at least a portion of the object by at least a portion of a free end of a fastening tail and at least a portion of a base having, on a surface thereof, a first side and a second side opposite said first side, and wherein said step of insertably engaging comprises insertably engaging said fastening tail, said fastening tail being attached at an attached end of said fastening tail to said base at said second side, at said free end of said fastening tail with a fastening head attached to said base at said first side, thereby preventing disengagement of said fastening tail and said fastening head.

28. The method of claim 26, wherein said step of insertably engaging comprises inserting said fastening tail into a passage of said fastening head.

29. The method of claim 28, wherein said step of insertably engaging comprises inserting said fastening tail into said passage such that at least one of a plurality of narrowly spaced ribs of said fastening tail engage with a pawl of said fastening head projecting within said passage.

30. The method of claim 26, further comprising insertably engaging a plurality of said fastening tails with a plurality of said fastening heads respectively in substantial transverse alignment with said plurality of said fastening tails.

31. The method of claim 30, further comprising, prior to insertably engaging said plurality of said fastening tails with said plurality of said fastening heads, unrolling at least one base of a roll of a plurality of deformable bases and separating said at least one base from a remainder of said roll.
